(19) United States
(12) Patent Application Publication
(10) Pub. No.: US 2025/0058378 A1
(43) Pub. Date: Feb. 20, 2025

(54) METHOD OF ADDITIVE MANUFACTURING AND METHOD OF MAKING POROUS PARTICLES

(71) Applicant: THE JOHNS HOPKINS UNIVERSITY, Baltimore, MD (US)

(72) Inventors: Adam B. PETERS, Baltimore, MD (US); Dajie ZHANG, Baltimore, MD (US); Alyssa CHUANG, Baltimore, MD (US); Dennis NAGLE, Ellicott City, MD (US)

(73) Assignee: THE JOHNS HOPKINS UNIVERSITY, Baltimore, MD (US)

(21) Appl. No.: 18/719,328

(22) PCT Filed: Dec. 12, 2022
(86) PCT No.: PCT/US2022/052489

§ 371 Date: Jun. 13, 2024

Related U.S. Application Data
(60) Provisional application No. 63/292,692, filed on Dec. 22, 2021.

(51) Int. Cl. B22F 3/11; B22F 10/28; B28B 1/00; B33Y 10/00

(52) U.S. Cl. CPC B22F 3/11; B22F 10/28; B28B 1/001; B33Y 10/00

(57) ABSTRACT

A method of additive manufacturing. The method comprises: i) positioning porous particles on a substrate, the porous particles having an average porosity and comprising at least one material chosen from metals and metalloids; ii) heating at least a portion of the porous particles to a reaction temperature; and iii) exposing the porous particles to a reactant gas to form a layer comprising a non-oxide ceramic. A method of making porous particles is also disclosed.

### CROSS-REFERENCE TO RELATED APPLICATIONS

This application is the national stage entry of International Patent Application No. PCT/US2022/052489, filed on Dec. 12, 2022, and published as WO 2023/121894 A1 on Jun. 29, 2023, which claims the benefit of U.S. Provisional Patent Application No. 63/292,692, filed on Dec. 22, 2021, all of which are hereby incorporated by reference herein in their entireties.

### GOVERNMENT FUNDING

This invention was made with Government support under grant no. N00014-16-1-2460 awarded by the United States Department of the Navy/Office of Naval Research. The Government has certain rights in the invention.

### FIELD OF THE DISCLOSURE

The present disclosure is directed to a method of additive manufacturing that employs porous particles. The present disclosure is also directed to a method of making porous particles.

### BACKGROUND

The production of structural non-oxides, including carbides, nitrides, and borides, using additive manufacturing (AM) remains relatively undeveloped. Non-oxide ceramic materials offer many favorable thermal, mechanical, and chemical properties for applications such as heating elements (B₄C, BN), electrodes (ZrB₂), cutting tools (WC), rocket nozzles (TiB₂), protective barriers for neutron speed reducers (BC), aerospace components (SiC), and power electronics modules (AIN).

Selective laser sintering (SLS) is a well-known AM technique that employs a laser in an inert atmosphere to sinter and bond together particle feedstocks in a powder bed to form three-dimensional (3D) products. The ability to construct isovolumetric non-oxide components from conventional ceramic feedstocks using SLS AM techniques has had limited success. Due to poor thermal shock resistance of non-oxides during the short interaction times between the laser and the feedstock powder, the layer-wise additive manufacturing of powder bed-based non-oxides using direct laser processing is difficult. Traditional approaches for forming ceramics that are compatible with AM include are multi-step and incorporate expendable binder phases that promote consolidation during processing. For example, established additive methods for non-oxides such as SiC and Si₃N₄ methods rely on indirect AM. These approaches involve SiC or Si₃N₄ feedstocks consolidated using organic binders during green body shaping. After pyrolysis for or binder burn out for SiC formation, molten Si infiltration (Mₚ=1410° C.) is typically used to increase part densities, prevent brown part disintegration, and improve mechanical properties. However, this impacts the materials' refractory qualities. For high temperature transition metal non-oxides like TaC, HfC, TiC, TiC, HfN, TiN, etc, consolidation is difficult due to strong atomic bonding and low diffusion characteristics rendering both direct and multi-step AM difficult. For lower melting point non-oxides, near full densities can be obtained from multi-step techniques, although high post-processing temperatures are employed to sinter particles, so parts are often subject to anisotropic consolidation, shape distortion, and significant volume changes.

Another type of additive manufacturing is known as selective laser reaction sintering (“SLRS”). The mechanism for non-oxide formation using SLRS has been outlined in five steps, as described by B. R. Birmingham et al., “Solid Freeform Fabrication of Silicon Carbide Shapes by Selective Laser Reaction Sintering (SLRS),” Proc. Solid Free. Fabr. Symp., pp. 308-316, 1995. These steps include: (1) A scanning laser locally heats a powder bed containing metal or metal oxide precursor particles; (2) The particles are heated to exceed thermodynamically spontaneous reaction carburization or nitridation conditions (can remain solid or be melted); (3) Reactant gas (e.g. CH₄, or NH₃) is adsorbed onto the surface of a heated particle where it decomposes into C/N and H₂; (4) Gas decomposition products desorb as adsorbed C or N diffuses into the heated particle; (5) C or N reacts with the metal or reduced species and leads to solution-reprecipitation of the final non-oxide. However, adoption of SLRS has been challenged by the poor structural integrity of the products as a result of interlayer delamination and cracking caused by residual stresses induced during processing.

There remains a need for improved methods for making non-oxide ceramics by additive manufacturing techniques.

### SUMMARY

An embodiment of the present disclosure is directed to a method of additive manufacturing. The method comprises: i) positioning porous particles on a substrate, the porous particles having an average porosity and comprising at least one material chosen from metals and metalloids; ii) heating at least a portion of the porous particles to a reaction temperature; and iii) exposing the porous particles to a reactant gas to form a layer comprising a non-oxide ceramic.

Another embodiment of the present disclosure is directed to a method of making porous particles. The method comprises: determining the percent volume increase between a precursor material and a non-oxide ceramic formed from the precursor material; determining a desired average porosity of porous particles based on the percent volume increase; and forming porous particles comprising the precursor material and having the desired average porosity, the precursor material comprising at least one material chosen from metals and metalloids.

It is to be understood that both the foregoing general description and the following detailed description are exemplary and explanatory only and are not restrictive of the present teachings, as claimed.

### BRIEF DESCRIPTION OF THE DRAWINGS

The accompanying drawings, which are incorporated in and constitute a part of this specification, illustrate embodiments of the present teachings and together with the description, serve to explain the principles of the present teachings.

FIG. 1 illustrates a flow diagram of a method of additive manufacturing, according to the present disclosure.

FIG. 2 illustrates an example of a 3D printer carrying out the method of FIG. 1, according to an embodiment of the present disclosure.

FIG. 3 illustrates an example of layers comprising the non-oxide ceramic selectively formed from portions of porous particle layers in a powder bed, according to an embodiment of the present disclosure.

FIG. 4A to 4C show SEM micrographs illustrating Ta precursors converted to TaC in CH₄ via SLRS, according to an example of the present disclosure.

FIG. 5 illustrates a flowchart of a method of making porous particles for use in manufacturing non-oxide ceramics, according to an embodiment of the present disclosure.

FIG. 6 shows XRD spectra illustrating chemical conversion of Ta precursors in CH₄ and NH₃ to TaC and TaN respectively via SLRS.

FIG. 7 illustrates a close up view of an example Ta porous particle microstructure showing ligands, according to the present disclosure.

It should be noted that some details of the figures have been simplified and are drawn to facilitate understanding of the embodiments rather than to maintain strict structural accuracy, detail, and scale.

### DETAILED DESCRIPTION

Reference will now be made in detail to embodiments of the present teachings, examples of which are illustrated in the accompanying drawings. In the drawings, like reference numerals have been used throughout to designate identical elements. In the following description, reference is made to the accompanying drawings that forms a part thereof, and in which is shown by way of illustration specific exemplary embodiments in which the present teachings may be practiced. The following description is, therefore, merely exemplary.

As additive manufacturing (AM) technologies continue to proliferate, the production of additively manufactured ceramics would benefit from the technical ability to fabricate mechanically robust and/or near-net shape components with the desired geometries. As is well known in the art, the desired geometries of a 3D product to be manufactured are generally determined and then specified in a digital data file used for controlling a 3D printer during the additive manufacturing process. The term “near-net shape”, as used herein, is taken to mean that the 3D product as initially completed by the additive manufacturing process (e.g., prior to any machining) has similar dimensions (e.g., less than 10% difference for all linear dimensions) to the target dimensions specified in the digital data file. The ability to use a reactive precursor material that accommodates specific metal-to-ceramic conversion-induced volume changes can maintain the macroscopic dimensions of a 3D part to prevent or reduce cracking and other stress-induced defects. This nano/microscale accommodation enables the fabrication of near net-shape products via additive manufacturing.

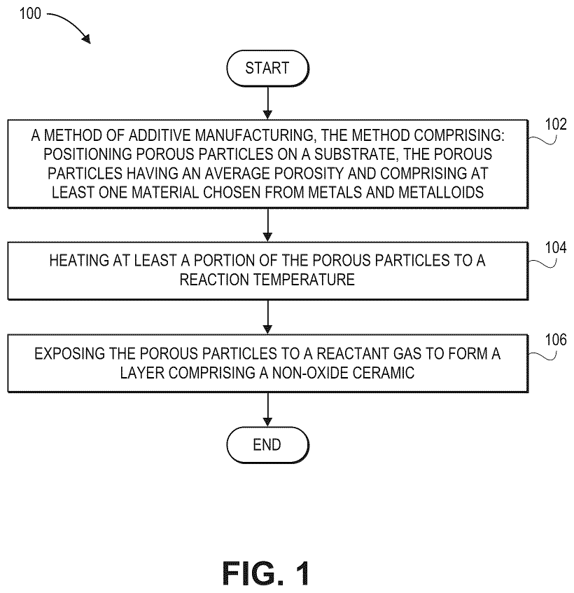

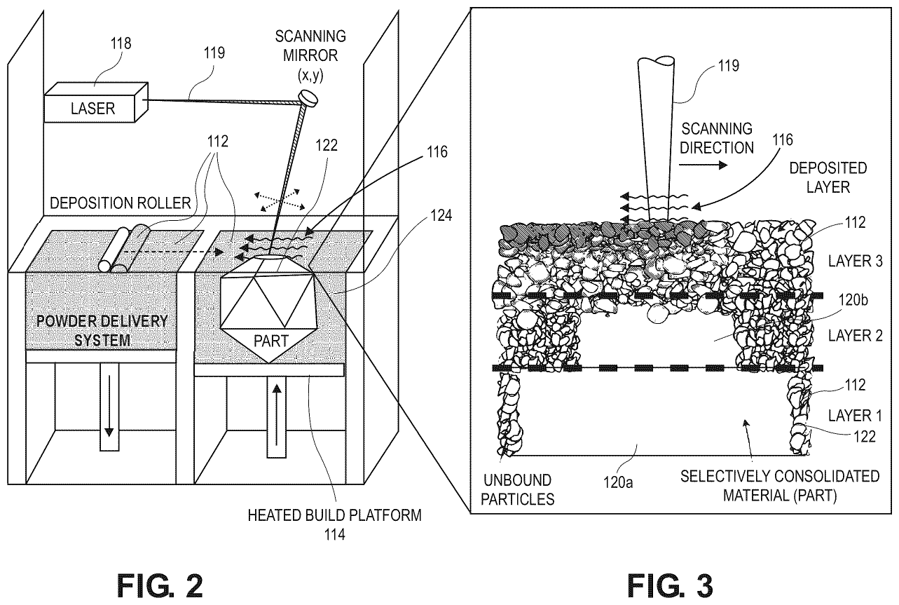

FIG. 1 is a flow diagram of a method of additive manufacturing 100 according to the present disclosure. FIG. 2 illustrates an example of a 3D printer 110 carrying out the methods of the present disclosure. As shown at 102 of FIG. 1, the method comprises positioning porous particles 112 (FIG. 2) comprising at least one material chosen from metals and metalloids on a substrate 114. The porous particles 112 have an average porosity that can be selected to provide one or more characteristics of the product being manufactured, as will be discussed in greater detail herein.

As shown at 104 and 106 of FIG. 1, the method further comprises selectively heating at least a portion of the porous particles 112 to a reaction temperature and exposing the porous particles 112 to a reactant gas 116. The heating can be carried out by any suitable technique, such as by employing a laser or electron beam. A laser 118 scans a top layer of the porous particles, supplying the heat for reaction of the particles with the reactant gas 116, as shown in FIGS. 2 and 3. During the heating and reaction with the reactant gas 116, the selectively heated porous particles bond together to form a layer comprising the non-oxide ceramic on the substrate 114. FIG. 3 illustrates an example of layers 120a and 120b (collectively referred to herein as layers 120) comprising the non-oxide ceramic selectively formed from a portion of particles 112. As shown in FIG. 3, the porous particles 112 are deposited sequentially in the powder bed 124 in layers (e.g., layers 1, 2 and 3 as shown in FIG. 3).

In addition to the selective heating described herein, additional thermal energy can be provided to the porous particles from other sources, such as heating of the substrate 114 using heating elements positioned within or proximate to the substrate 114. As an example, the porous particles can be heated using the substrate 114 to a temperature that is below the desired reaction temperature, followed selectively heating using the laser or other selective heating technique to achieve the desired reaction temperature.

Following formation of the layer 120a comprising the non-oxide ceramic from the particles of layer 1, the method optionally comprises forming additional layer 120b, where the process of forming the additional layer is similar to that described above for layer 120a, including positioning additional porous particles 112 (shown as layer 2) on the already formed layer or layers in the powder bed 124. The additional porous particles 112 have an average porosity and comprise at least one material chosen from metals and metalloids. The additional porous particles are selectively heated to the reaction temperature and exposed to the reactant gas to form additional layer 120b comprising the non-oxide ceramic. This process of positioning additional porous particles 112 on the previously deposited layers, followed by heating and expositing the porous particles to the reactant gas to form additional layers comprising non-oxide ceramic can be repeated a plurality of times to form a 3D printed product 122 on the substrate 114.

The porous particles 112 can comprise any metal or metalloid material. In an embodiment, the material is a metal chosen from transition metals such as Ti, Hf, Ta, Zr, V, Nb, Cr, Mo, Co, Ni, Tc, Os, Re, W, Mn and Fe; post-transition metals such as Al and Ga; or a metalloid, such as silicon or boron.

The average porosity of the porous particles 112 used to form each layer 120a, 120b can be the same or different. The average porosity of the porous particles can be chosen so as to provide various different characteristics of the final product, as desired. For example, the average porosity of the porous particles can be chosen to result in a desired porosity of the final 3D printed product 122, where the porosity of the 3D printed product 122 will be less than the porosity of the porous particles 112. In an example, the porosity of the 3D printed product is less than 85% by volume, such as about 0 to about 70%, or about 5 to about 50% by volume. For many applications, dense ceramics with relatively low porosities are favorable, such as porosities of about 0 to about 5% porosity by volume, or about 0 to about 2% porosity, or about 0 to about 1%, or about 0 to about 0.5% porosity by volume. For other applications, such as catalysis, porous ceramics are the target, with porosities up to 90%, such as about 50% to about 85%.

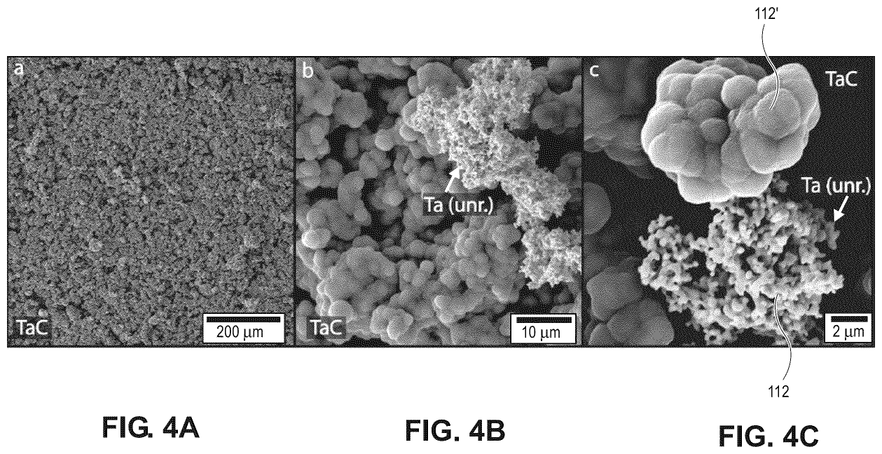

Expansion of the particle material occurs during the reaction that converts the porous particle 112 to ceramic. The bottom half of FIG. 4C shows an example of a porous particle 112 comprising tantalum prior to reaction. The top half of FIG. 4C shows an example of a stand-alone ceramic particle 112′ comprising tantalum carbide after reaction of a porous particle with a carbon-containing gas, illustrating an increased densification and closing of pores that can occur during growth of the ceramic from the porous particle.

In an embodiment, the average porosity of the porous particles 112 can be chosen to allow for a reduction in stress and/or cracking of the layers 120 due to a volume change that occurs during the subsequent reaction that produces the non-oxide ceramic from the porous particles 112. In an embodiment, the non-oxide ceramic has a percent volume increase relative to the porous particles 112, where the percent volume increase is about equal to the average porosity of the porous particles. This can result in relatively small amounts of expansion during growth of the ceramic from the particle material and a near-net shape of the 3D printed product 122. This can be a significant improvement when compared to processes that employ solid particles or other particles with inadequate porosity, which can result in excessive expansion and undesirable stress and/or cracking of the materials during reaction to form the ceramics.

The average porosity of the particles will depend on the particle material, and the desired porosity of the final product, among other things. As general examples, the particle porosity can range from about 2% to about 95% by volume, such as about 7% to about 80%, such as about 15% to about 60%, or about 20% to about 50%, or about 25% to about 40%. As described herein, where dense ceramics are the target, the average porosity is chosen to be about the same as the percent volume increase between the particle material and the non-oxide ceramic. Table 1 below shows examples of volume changes realized when converting certain metals to carbides or nitrides. Note that these volume changes may vary depending on the reaction details and end product for each metal, so the volume changes below are merely to be taken as examples. Broad and narrow example porosity ranges for metal particles that can be used to achieve relatively dense ceramic products are also provided in the table. These are merely examples, and porosities outside of the listed ranges can be used.

| | | | | Broader and narrower |
|---|---|---|---|---|
| | | | Volume | example porosity |
| | | | Change | ranges of |
| | | | Upon | metal particles |
| | | | Conversion | for dense |
| Metal | Gas | Carbide | (%) | ceramic (vol %) |
| Ti | CH4 | TiC | 14 | 10 to 20, 12 to 16 |
| Ta | CH4 | TaC | 24 | 20 to 30, 22 to 26 |
| Zr | CH4 | ZrC | 11 | 5 to 15, 9 to 13 |
| Si | CH4 | SiC | 3 | 1 to 5, 2 to 4 |
| Hf | CH4 | HfC | 14 | 10 to 20, 12 to 16 |
| Cr | CH4 | Cr3C2 | 24 | 20 to 30, 22 to 26 |
| Cr | CH4 | Cr7C3 | 14 | 10 to 20, 12 to 16 |
| Cr | CH4 | Cr23C6 | 8 | 4 to 12, 6 to 10 |
| | | | Volume | |
| | | | Change | |
| | | | Upon | |
| | | | Conversion | |
| Metal | Gas | Nitride | (%) | |
| Hf | NH3 | HfN | 3 | 1 to 5, 2 to 4 |
| Al | NH3 | AlN | 26 | 20 to 30, 24 to 28 |
| Cr | NH3 | CrN | 51 | 45 to 55, 49 to 52 |
| Cr | NH3 | Cr2N | 21 | 15 to 25, 19 to 23 |
| Zr | NH3 | ZrN | 5 | 2 to 8, 3 to 6 |
| Si | NH3 | Si3N4 | 21 | 15 to 25, 19 to 23 |
| Ti | NH3 | TiN | 12 | 5 to 15, 10 to 14 |

In the additive manufacturing processes described herein, any suitable reactant gas 116 can be employed that will react with the porous particles 112 to produce layers 120 comprising the non-oxide ceramic material. In an embodiment, the reactant gas 116 comprises at least one gas selected from a carbon containing gas that does not contain significant amounts of oxygen (e.g., no or trace amounts of oxygen), such as a short hydrocarbon having 1 to 6 carbon atoms (e.g., methane or ethane); a nitrogen containing gas that does not contain significant amounts of oxygen, such as ammonia or nitrogen gas (N₂); or a boron containing gas that does not contain significant amounts of oxygen, such as boron hydrides (e.g., BH₃, B₂H₆ (diborane), B₃H₇ or higher boranes).

The resulting layers 120 can comprise any suitable non-oxide ceramic, such as carbides, nitrides or borides, or a mixture thereof. As examples, the non-oxide ceramic can comprise at least one material selected from metal carbides, metal nitrides, metal borides, metalloid nitrides, metalloid carbides, and metalloid borides. Further examples of such materials include carbides, nitrides and borides of Ti, Hf, Ta, Zr, V, Nb, Cr, Mo, Co, Ni, Tc, Os, Re, W, Mn, Fe, Ga, Al and Si, as well as boron nitrides and boron carbides. Still further examples include tantalum carbides (e.g., TaₓC_{y}, such as TaC, Ta₂C and TaC_{0.94}), tantalum nitrides (e.g., TaₓN_{y}, such as Ta₂N, TaN, Ta₅N₆, Ta₄N₅, Ta₂N₃, and Ta₃N₅), silicon carbides (e.g., SiC), silicon nitrides (e.g., Si₃N₄), aluminum nitrides (e.g., AIN), titanium nitrides (e.g., TiₓN_{y}, such as Ti₂N and TiN_{˜1.0}), titanium carbides (e.g., TiₓC_{y}, such as TiC_{˜1.0}), chromium carbides (e.g., CrₓC_{y}, such as Cr₂₃C₆), hafnium carbides (e.g., HfₓC_{y}, such as HfC) and hafnium nitrides (e.g., HfₓN_{y}, such as Hf₃N₄, HfN_{˜1.0}, Hf₄N₃ Hf₃N₂, HfN_{0.25}, Hf₅N₆, and Hf₆N₅), where x and y indicate the relative stoichiometry of the metal and C or N atom. Small amounts, (e.g., generally less than 5 mol %, or less than 2 mol %) of impurities (e.g., oxygen or other impurities) may or may not be present in the final non-oxide ceramic products, such as any of the compounds listed above, depending on reaction conditions, the amount of unreacted reactants, oxidating impurities in the reactants and processing atmosphere and so forth, as would be understood by one of ordinary skill in the art.

Any suitable additive manufacturing method that allows for reaction of the porous particle material to form a non-oxide ceramic can be employed. Generally, the porous particles 112 are positioned on the substrate 114, such as a build plate of an additive manufacturing apparatus, where they are heated and exposed to the reaction gas 116. In an embodiment, the method of additive manufacturing is selective laser reaction sintering (“SLRS”). SLRS can produce net-shape non-oxide ceramics and/or volume/porosity tunable non-oxide ceramics via additive manufacturing, as described herein, by employing the porous particles 112, which are converted to the desired end state ceramic. The SLRS process employs an in-situ gas-solid or gas-liquid reaction synthesis process for sintering or otherwise bonding the porous particles, as also described in greater detail herein. The term “in-situ” as used herein means that the reaction sintering of the particles occurs in the same chamber as the 3D printing of the product 122. In an embodiment, the reaction sintering occurs simultaneously as the product is shaped using selective heating of the particles, such as described above with respect to FIGS. 2 and 3.

As described herein, SLRS is based on chemical reactivity and reaction synthesis techniques, unlike SLS (described above) that involves chemically inert processes, where a feedstock material is processed in Ar or another inert gas to create parts of the same chemical composition as the powder bed. In SLRS, as selective irradiation occurs, conversion to refractory non-oxides is achieved through gas-solid (or gas-liquid) nitridation, carburization or other reactions between heated precursor particles (metals or metal oxides) and a gas-decomposition product (e.g., C from CH₄ or N from NH₃). Any suitable reaction gas, such as any of the reaction gases described herein, can be employed to provide the gas-decomposition product. While other bonding mechanisms may be possible, it is believed that reaction bonding (i.e., chemically induced binding) can serve as a primary mechanism of particle adhesion under photothermal irradiation because precursor components are converted by thermally-initiated in-situ chemical reactions within a reactive atmosphere. During SLRS, localized laser heating simultaneously initiates the sintering, inter-particle bonding, and chemical conversion of solid precursors (by thermally induced reactions with the atmosphere) as the desired product phase is formed during layer-by-layer fabrication. As described herein, volume changes are associated with the reactions of precursor components (for example expansion from the conversion of metal by carburization or nitridation). Table I shows some example synthesis reaction mechanisms compatible with SLRS, where “M” represents metals or metalloids; g, s, l respectively represent gas, solid or liquid, and x and y represent stoichiometric amounts of atoms in a compound.

TABLE I
Preparation methods for metal carbides and nitridescompatible
with SLRS

| Method | Reaction |
|---|---|
| (1) Direct synthesis by reaction | M₍ₛ₎ + CₓH_{y(g)} [symbol] |
| sintering or melting of metals | MC₍ₛ₎ + H_{2(g)} |
| with carburizing atmosphere. | |
| (2) Direct gas-solid synthesis by | M₍ₛ₎ + N_{2(g,I)} [or NH_{3(g)}] [symbol] |
| reaction sintering or melting of | MN₍ₛ₎ |
| metals in a nitriding atmosphere | |

In an embodiment, the porous particles 112 employed in the processes of the additive manufacturing processes of the present disclosure do not include a polymer binder. For example, porous particles 112 including only, or substantially only, metal or metalloid particles can be employed in the powder bed 124 of the 3D printer.

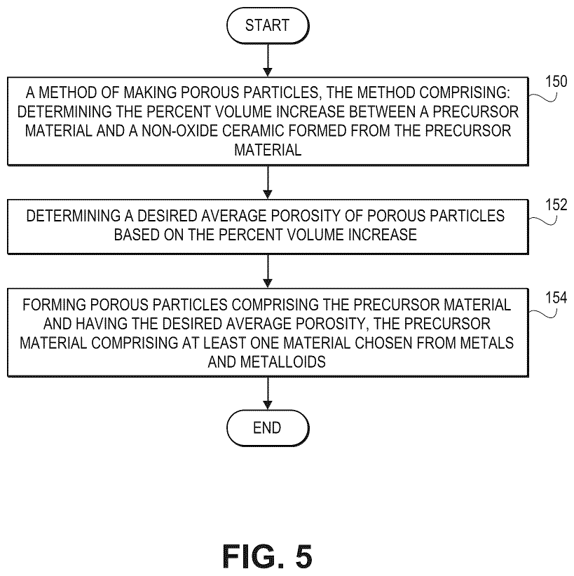

FIG. 5 illustrates a flowchart of a method of making porous particles for use in manufacturing non-oxide ceramics, according to an embodiment of the present disclosure. As shown at 150, the method comprises determining the percent volume increase between a particle material and a non-oxide ceramic formed from the particle material. As shown at 152, a desired average porosity of porous particles 112 is then determined for achieving at least one of: i) a desired porosity of a 3D printed product 122 comprising the non-oxide ceramic made from the porous particles; ii) a desired near-net shape of the 3D printed product; or iii) a desired dimensional change of the 3D printed product relative to the near-net shape; or iv) a desired reduction in stress and/or cracking of the 3D printed product relative to the stress and/or cracking that would occur if solid (e.g., non-porous) particles were used.

After determining the desired average porosity of the porous particles 112, porous particles are then formed having the desired average porosity, as shown at 154. In an embodiment, the average porosity is chosen to be about the same as the percent volume increase between the particle material and the non-oxide ceramic. Alternatively, the average porosity is chosen to be greater than the percent volume increase so as to produce a final product with a desired porosity. In yet another embodiment, the average porosity is chosen to be less than the percent volume increase so that the final part has a desired size increase and/or stress level compared to what it would otherwise have if the particle porosity was greater. The particles can be made of any of the particle materials disclosed herein.

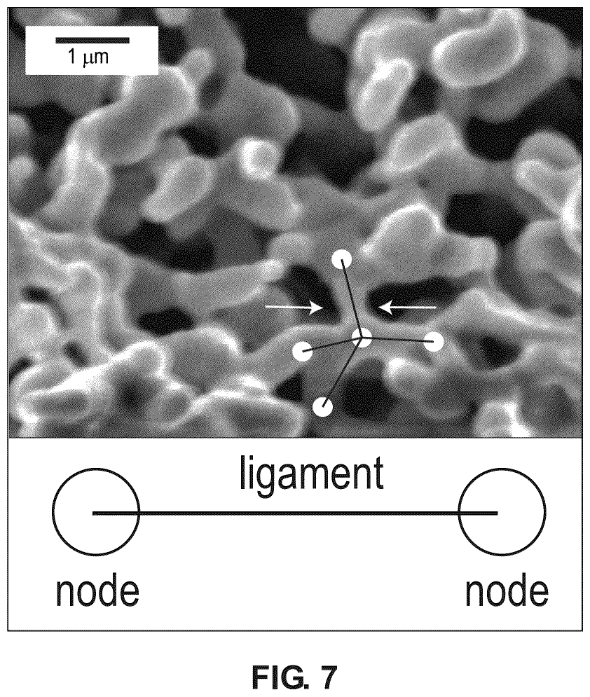

Gas-solid reactions in the additive manufacturing method, such as SLRS, can be limited by carbon or nitrogen diffusion into the converted ceramic layer as it is formed at the surface of the particle material. In an embodiment, to achieve complete or substantially complete conversion to ceramic and obtain a desired part geometry, it is helpful for the metal particles to satisfy the following:
1) Microstructure or ligaments (e.g., as shown in FIG. 7) are approximately 2 times greater than the conversion depth under the reaction conditions and reaction times to be used in the 3D printing process in order to allow the reaction conversions to penetrate the entire particle outward-in;
2) Overall porosity is chosen to allow for compensation to maintain net shape conversion and the ability to form dense or porous non-oxide ceramic products; and
3) The microstructure, including the porosity, of the particles can be homogeneous, or substantially homogeneous.

Any suitable techniques for forming the porous particles to achieve the desired porosity can be employed. Examples of suitable methods include forming the porous particles by reduction of a metal compound chosen from metal hydrides, metal chlorides and metal oxides. Another example includes forming the porous particle by aggregation of particles having a particle size ranging from nanometers to microns (e.g., about 10 nanometers to about 100 micrometers). Still other techniques include dealloying, sol-gel processing or spinodal decomposition techniques. Such methods of forming porous materials are well known in the art and one of ordinary skill in the art would be able to employ such methods to make the porous particles of the present disclosure without undue experimentation.

Using the above methods for manufacturing particles, selective porosity of porous particles can be tuned to provide desired 3D product characteristics. For example, alterations in porosity and/or reactivity of the porous particles can be used to intentionally engineer residual porosity and/or to provide reduced stress and cracking, according to the physicochemical requirements of the end-use application.

### EXAMPLES

### Example 1: Determining Particle Porosity for TaC and TaN Particles That Can Used for the Additive Manufacturing Methods Described Herein

Table II below shows the percent volume change when converting Ta to TaC and TaN.

TABLE II
Example TaC and TaN Synthesis via Porous Metal Precursor

| | | | | Est. | |
|---|---|---|---|---|---|
| | | | | Spon- | |
| | | Solid | | taneous | |
| | Solid | Precursor | | Reaction | Volume |
| Product | Phase | Mp | Reaction with | Temp. | Change |
| (Mₚ) | Precursor | (° C.) | CH₄ or NH₃ | (° C.) | (%) |
| TaC | Ta | 3017 | Ta + CH₄ → | ~25 | +24.2% |
| (4010° C.) | | | TaC + H₂ | | |
| TaN | Ta | 3017 | 2Ta + 2NH₃ → | ~25 | +30.9 |
| (3355° C.) | | | 2TaN + 3H₂ | | |

*Note
TaC is the highest known melting point binary material in existence.

Given the volume changes associated with the conversion of Ta to TaC and TaN, fully dense and near-net shape components can be fabricated if ˜24.2% and ˜30.9% porosity were incorporated into the Ta precursor component for additive manufacture of TaC and TaN, respectively.

### Example 2: Selective Laser Reaction Synthesis of TaC by Conversion of Ta Precursors Using CH4

TaC was made by SLRS of porous Ta particles of about 325 mesh, which are commercially available as Product Number 262846 from Sigma Aldrich of St. Louis, Missouri. SEM microscopy of the porous particles used is shown in FIG. 4B, which depicts bicontinuous, nanoporous Ta particles. Nanoporosity within the precursor was associated with a volumetric occupancy of 14 vol %.

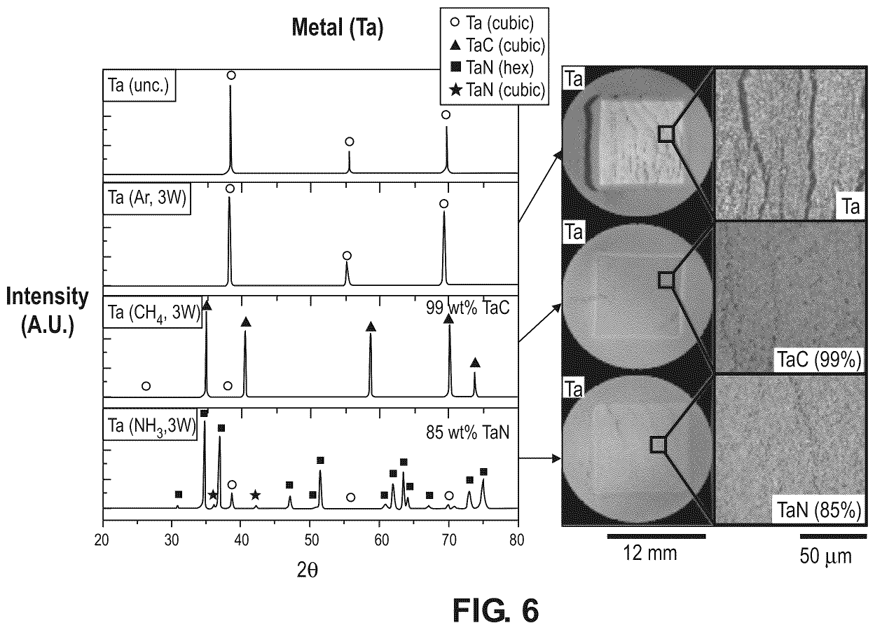

Conversion of Ta by CH₄ using 3W laser power produced impressively high yields (e.g., 99 wt % TaC_{1.0}). Conversion of nanoporous precursors was favored due to two effects: decreased diffusion C/N length scales and increased reactant penetration. Results show the impact of unique precursor morphology also has a profound effect on SRLS product layer microstructures. In addition, the degree of volume change (˜24.2 vol %) for Ta→TaC_{1.0} did not result in significant surface cracking in the sintered layer on a macroscopic scale (FIG. 6) which can occur for conversion of dense (non-porous) particles. Rather, an inspection of the TaC reaction product shows that volume changes were generally accommodated by residual porosity on the nanoscale (FIG. 4a). The SEM micrographs shown in FIGS. 4a to 4c illustrate Ta precursors converted to TaC in CH4 via SLRS and shows a comparison of reaction-induced volume changes, densification, and closure of porosity.

These results related to nanoporous precursor conversion suggest that an approach to producing stress relieved AM-non-oxides is to use porous materials that are microstructurally engineered to accommodate expansion as they convert to the desired end state ceramic. Precursor particle density and porosity influence both the scale at which volume changes occur and the macroscopic layer morphology even if volumetric occupancy is generally conserved. Using this type of processing scheme, non-oxide synthesis net-shape geometries might be achieved.

### Example 3: Selective Laser Reaction Synthesis of TaN by Conversion of Ta Precursors Using NH3

TaN was made by SLRS of porous Ta particles using NH₃ as the reactant gas at 3W laser power. The Ta particles were the same as those used in Example 2.

Results show that the degree of volume change for Ta→TaN resulted in a relatively small amount of surface cracking in the sintered layer on a macroscopic scale than was seen for the TaC of Example 2, as shown (FIG. 6). However, the surface cracking was somewhat higher that was seen for the TaC of Example 2. It is believed it may be possible to reduce the surface cracking by increasing the porosity of the porous particles to be closer to the about ˜30.9% porosity determined based on the amount of expansion that occurs during conversion to the ceramic, for the reasons discussed in Example 1.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein.

While the present teachings have been illustrated with respect to one or more implementations, alterations and/or modifications can be made to the illustrated examples without departing from the spirit and scope of the appended claims. In addition, while a particular feature of the present teachings may have been disclosed with respect to only one of several implementations, such feature may be combined with one or more other features of the other implementations as may be desired and advantageous for any given or particular function. Furthermore, to the extent that the terms “including,” “includes,” “having,” “has,” “with,” or variants thereof are used in either the detailed description and the claims, such terms are intended to be inclusive in a manner similar to the term “comprising.” Further, in the discussion and claims herein, the term “about” indicates that the value listed may be somewhat altered, as long as the alteration does not result in nonconformance of the process or structure to the illustrated embodiment. Finally, “exemplary” indicates the description is used as an example, rather than implying that it is an ideal.

Other embodiments of the present teachings will be apparent to those skilled in the art from consideration of the specification and practice of the present teachings disclosed herein. It is intended that the specification and examples be considered as exemplary only, with a true scope and spirit of the present teachings being indicated by the following claims.

What is claimed is:

1. A method of additive manufacturing, the method comprising:
i) positioning porous particles on a substrate, the porous particles having an average porosity and comprising at least one material chosen from metals and metalloids;
ii) heating at least a portion of the porous particles to a reaction temperature; and
iii) exposing the porous particles to a reactant gas to form a layer comprising a non-oxide ceramic.

2. The method of claim 1, further comprising, prior to i), determining a desired average porosity of porous particles, the desired average porosity of the porous particles resulting in: i) a desired porosity of a 3D printed product comprising a non-oxide ceramic made from the porous particles; or ii) a desired near-net shape of the 3D printed product.

3. The method of claim 1, wherein the non-oxide ceramic has a percent volume increase relative to the porous particles, the percent volume increase being about equal to the average porosity of the porous particles.

4. The method of claim 1, further comprising:
iv) positioning additional porous particles on the layer comprising the non-oxide ceramic, the additional porous particles having a second average porosity and comprising at least one material chosen from metals and metalloids; and
v) heating the additional porous particles to the reaction temperature; and
vi) exposing the additional porous particles to the reactant gas to form a second layer comprising the non-oxide ceramic; and
vii) repeating iv) to vi) a plurality of times to form a 3D printed product on the substrate.

5. The method of claim 4, wherein the average porosity and the second average porosity are the same.

6. The method of claim 4, wherein the 3D printed product has a near-net shape.

7. The method of claim 1, wherein the average porosity ranges from about 10% to about 80%.

8. The method of claim 1, wherein the material is a metal or metalloid chosen from Ti, Hf, Ta, Zr, V, Nb, Cr, Mo, Co, Ni, Tc, Os, Re, W, Mn, Fe, Ga, Al, Si, B or alloys thereof.

9. The method of claim 1, wherein the reactant gas comprises at least one gas selected from a hydrocarbon, ammonia, nitrogen gas and boron hydrides.

10. The method of claim 1, wherein the non-oxide ceramic comprises at least one material selected from metal nitrides, metal carbides, metal borides, metalloid nitrides, metalloid carbides and metalloid borides.

11. The method of claim 1, wherein the method of additive manufacturing is selective laser reaction sintering.

12. The method of claim 1, wherein the substrate is the build plate of 3D printer.

13. The method of claim 1, wherein the porous particles do not include a polymer binder.

14. A method of making porous particles, the method comprising:
determining the percent volume increase between a precursor material and a non-oxide ceramic formed from the precursor material;
determining a desired average porosity of porous particles based on the percent volume increase; and
forming porous particles comprising the precursor material and having the desired average porosity, the precursor material comprising at least one material chosen from metals and metalloids.

15. The method of claim 14, wherein the desired average porosity is chosen to be about the same as the percent volume increase.

16. The method of claim 14, wherein forming the porous particle comprises reduction of a metal compound chosen from metal hydrides, metal chlorides and metal oxides.

17. The method of claim 14, wherein forming the porous particle comprises aggregation of particles having a particle size ranging from about 10 nanometers to about 100 micrometers.

18. The method of claim 14, wherein forming the porous particle comprises dealloying.
